(19) United States
(12) Patent Application Publication
(10) Pub. No.: US 2013/0160504 A1
(43) Pub. Date: Jun. 27, 2013

(54) HYDRAULICALLY-CODED LOCK MECHANISM

(71) Applicant: Yueping ZHOU, Shenzhen (CN)

(72) Inventor: Yueping ZHOU, Shenzhen (CN)

(21) Appl. No.: 13/773,591

(22) Filed: Feb. 21, 2013

Related U.S. Application Data
(63) Continuation-in-part of application No. PCT/CN2011/078692, filed on Aug. 22, 2011.

(30) Foreign Application Priority Data
Aug. 26, 2010 (CN) 201010263641.8

(51) Int. Cl. E05B 51/02

(52) U.S. Cl. CPC E05B 51/02
USPC 70/275

(57) ABSTRACT

A hydraulically-coded lock mechanism for encoding a locked space formed by a housing and a bolt body. The hydraulically-coded lock mechanism includes: an endec for controlling a connecting part between the housing and the bolt body; and a hydraulic converting element connected to the endec. The endec is fully disposed inside the locked space. The hydraulic converting element converts a hydraulic signal into a mechanical movement of the endec or a photoelectric signal to drive the endec to decode.

### CROSS-REFERENCE TO RELATED APPLICATIONS

This application is a continuation-in-part of International Patent Application No. PCT/CN2011/078692 with an international filing date of Aug. 22, 2011, designating the United States, now pending, and further claims priority benefits to Chinese Patent Application No. 201010263641.8 filed Aug. 26, 2010. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 14781 Memorial Drive, Suite 1319, Houston, Tex. 77079.

### BACKGROUND OF THE INVENTION

1. Field of the Invention

The invention relates to a lock mechanism, and more particularly to a hydraulically-coded lock mechanism.

2. Description of the Related Art

A typical burglarproof coded technology mainly includes: a mechanically-coded technology, an electronically-coded technology, and a hydraulically-coded technology. However, these technologies are disadvantageous in the following aspects. For the mechanically-coded lock, because a coding device and a decoding device are connected together, a remote decoding cannot be realized by using the mechanically-coded technology. Although the remote decoding can be realized by the electronically-coded technology, burglars can easily decode the lock by using a computer, since the operating speed of the computer becomes much faster; besides, the electric circuit is very easy to be supervised, so that the risk of robbery is increased. The current hydraulically-coded technology mainly uses mechanically-coded technology and the electronically-coded technology to control an oil path. A typical hydraulically-coded technology includes hydraulic valves, such as a relief valve. However, these hydraulic valves are only used as functional elements in the hydraulic system, rather than functional elements in the process of coding or decoding. Thus, this kind of hydraulically-coded technology still belongs to the category of mechanically-coded technology and the electronically-coded technology.

### SUMMARY OF THE INVENTION

In view of the above-described problems, it is one objective of the invention to provide a hydraulically-coded lock mechanism that realizes the remote decoding and is more safety.

An oil duct in the invention is an enclosed channel in which hydraulic oil flows, for example, an oil pipe.

An oil path in the invention is the enclosed channel in which hydraulic oil flows and hydraulic elements.

To achieve the above objectives, in accordance with one embodiment of the invention, there is provided a hydraulically-coded lock mechanism for encoding a locked space formed by a housing and a bolt body. The hydraulically-coded lock mechanism comprises: a bolt controlling device comprising an endec; and a hydraulic converting element disposed inside the locked space. The endec controls a connecting part between the housing and the bolt body. The endec is totally disposed inside the locked space, and connected to the hydraulic converting element. The endec is driven by the hydraulic converting element. The hydraulic converting element converts a hydraulic signal into a mechanical movement of the endec or a photoelectric signal to drive the endec to decode. The endec herein is a mechanical endec or an electromechanical endec. The endec is driven by the hydraulic converting element to locking the housing and the bolt body.

The hydraulic converting element has two types, a first type of hydraulic converting element comprises: a hydraulic cylinder, and/or a hydraulic motor; a piston rod of the hydraulic cylinder and/or an output shaft of the hydraulic motor are/is connected to the endec.

When the endec is the mechanical endec or the electromechanical endec, generally, the endec further comprises a latching mechanism for locking the housing and the bolt body to form the locked space. Driven by the forward and backward movement of the piston rod of the hydraulic cylinder or the rotation of the output shaft of the hydraulic motor, the endec unlocks the locked space. A specific structure of the latching mechanism varies in compliance with the different structures of the hydraulically-coded lock mechanism.

A second type of hydraulic converting element comprises: a pressure sensor, a flow sensor, a rotational speed sensor, a displacement sensor, a pressure relay, or a combination thereof; as well as the above hydraulic motor and/ or hydraulic cylinder.

When the hydraulic converting element comprises: the pressure sensor, the flow sensor, the rotational speed sensor, the displacement sensor, the pressure relay, or the combination thereof, the endec is provided with a signal detection controller preset with a range of a moving distance. The signal detection controller is in electric connection with the above sensors for detecting signals, such as a pressure, a flow volume, a rotational speed, or a displacement signal. Only when the detected signals are all meet the preset parameters, the connected part of the housing and the bolt body is opened by the endec.

The hydraulically-coded lock mechanism further comprises a hydraulic decoding device comprising a hydraulic regulating element. The hydraulic decoding device is connected to the hydraulic converting element via an oil duct. The hydraulic regulating element comprises a manual reversal valve, a hand oil pump, a pressure control valve, a flow control valve, a directional control valve, or a combination thereof. At least two hydraulic regulating elements further comprise a regulating terminal; and the regulating terminal is disposed outside the locked space. A plurality of hydraulic decoding devices are connected in parallel and/or in series via the oil duct. When the hydraulic decoding devices are all connected in parallel, the hydraulic decoding devices operate independently with each other, and once one hydraulic decoding device is successfully operated, the hydraulically-coded lock mechanism is unlocked. When the hydraulic decoding devices are all connected in series, the hydraulically-coded lock mechanism can be unlocked on the premise of successful operation of all the hydraulic decoding devices, so that the security of the series connection of the hydraulic decoding devices is higher than that of the parallel connection of the hydraulic decoding devices. When the hydraulic decoding devices are connected in series as well as in parallel, different hydraulic decoding devices forms a logical restriction between each other, only the operation of the hydraulic decoding devices meet the logical requirements, is the lock mechanism unlocked. The hydraulic decoding device is disposed inside the locked space, or outside the locked space. For the hydraulically-coded lock mechanism that is not usually decoded, the hydraulic decoding device is not necessitated, because the hydraulic decoding device is connected to the hydraulic converting element via the oil duct, and it is very convenient to assemble or dissemble the hydraulic decoding device via the oil duct; thus, a plurality of such hydraulically-coded lock mechanisms can share a single hydraulic decoding device.

In accordance with another embodiment of the invention, there provided is a hydraulically-coded lock mechanism for encoding a locked space formed by a housing and a bolt body. The hydraulically-coded lock mechanism comprises: a bolt controlling device comprising a hydraulic converting element; and an endec comprising at least two hydraulic regulating elements comprising a regulating terminal. The hydraulic converting element is disposed inside the locked space; the endec is partially disposed inside the locked space and connected to the hydraulic converting element via an oil duct; the regulating terminal is disposed outside the locked space. Besides the above hydraulic regulating elements, the endec further comprises at least two oil duct interfaces disposed outside the locked space for connecting a hydraulic decoding device disposed outside the locked space.

The second technical scheme is different from the first technical scheme in that the endec of the second technical scheme controls the hydraulic converting element to realize the lock between the housing and the bolt body, this kind of endec is a hydraulic endec.

The hydraulic converting element comprises a hydraulic cylinder and/or a hydraulic motor; and the hydraulic converting element further comprises a pressure sensor, a flow sensor, a rotational speed sensor, a displacement sensor, a pressure relay preset with a range of moving distance, or a combination thereof.

The hydraulic regulating element comprises a hand oil pump, a manual reversal valve, a pressure control valve, a flow control valve, a pilot operated directional control valve, or a combination thereof. The pressure control valve and the flow control valve comprise a hydraulic controlled pressure control valve and a hydraulic controlled flow control valve. To be noticed, a pressure control valve, a flow control valve, and a pilot operated directional control valve that are manually controlled are used for adjusting a handle disposed in an oil duct inside the locked space, because these valves cannot be regulated outside the locked space, they do not fall into a range of the above hydraulic regulating element.

When the hydraulic converting element comprises: the pressure sensor, the flow sensor, the rotational speed sensor, the displacement sensor, the pressure relay, or the combination thereof; a signal detection controller preset with a range of a moving distance is necessitated. The signal detection controller is in electric connection with the above sensors for detecting signals, such as a pressure, a flow volume, a rotational speed, or a displacement signal. The hydraulic converting element is used to regulate the pressure, the flow volume, the rotational speed, and the displacement signal. Only when the detected signals are all meet the preset parameters of the signal detection controller, or the parameter of the pressure relay meets the preset parameter, the connected part of the housing and the bolt body is opened by the hydraulic converting element.

When the endec is the hydraulic endec, it often comprises: the hydraulic regulating element comprising the regulating terminal, and a hydraulic regulating element that are hydraulic controlled. The regulating terminals are arranged outside the locked space for controlling the hydraulic converting element to reach the preset parameters to decode, thus, a hydraulic decoding device is not necessitated for a local decoding. However, to realize the remote decoding, at least one hydraulic decoding device is provide outside the locked space and connected to the hydraulic converting element via an oil duct of the hydraulic endec disposed outside the locked space. To realize the local decoding, a hydraulic decoding device can be arranged independently inside the locked space, beside the endec.

The same as the first technical scheme, according to a decoding principle of the hydraulic endec, the hydraulic decoding device of the second technical scheme comprises: a hydraulic regulating element and/or hand oil pump. The hydraulic regulating element comprises a pressure control valve, a flow control valve, a directional control valve, or a combination thereof. Furthermore, a plurality of hydraulic decoding devices are connected by oil ducts and in parallel and/or series connection.

The manual reversal valve in the first and the second technical scheme are different from that of the prior art. The manual reversal valve in the prior art is mainly a rotary valve or a slide valve comprising a connecting bar controlling mechanism; and the manual reversal valve comprises: a valve body, a valve core, and a hand arranged on the valve core. A plurality of oil ports are arranged on the valve body and the valve core. An oil path can be opened, only when the corresponding oil ports on the valve core and the valve body, respectively, are connected by rotating the handle or by swinging the connecting bar controlling mechanism. The rotary valve can be encoded within a rotary range of ° of the handle, and the connecting bar controlling mechanism of the sliding valve can be encoded within a swinging rang thereof. However, the manual reversal valve of the invention employs a thread to drive the valve core to move inside the valve body, a match between the thread disposed on the valve body/the handle and the thread on the valve core controls an axial movement of the valve core. The code is preset by moving a screw pitch. When the handle rotates for one revolution, the valve core correspondingly moves precisely for one screw pitch.

In accordance with still another embodiment of the invention, there provided is a hydraulically-coded lock mechanism for encoding a locked space formed by a housing and a bolt body. The hydraulically-coded lock mechanism comprises: a bolt controlling device comprising a hydraulic converting element and an endec; and an alarm disposed on an oil path on which the hydraulic converting element arranged. The hydraulic converting element is disposed inside the locked space and connected to the endec. The endec is partially or totally disposed inside the locked space. The alarm is a pressure signal switch.

The pressure signal switch is arranged on any of the oil ducts that are directly or indirectly connected to the hydraulic converting element. The movement of the hydraulic converting element is pushed by the oil in the oil path. The pressure signal in an oil path between the oil pump and the hydraulic converting element are converted to other signals, such as the electronic signal, by the pressure signal switch, thereby warning that the bolt controlling device is opening. Thus, the pressure signal switch largely improves the security of the lock mechanism.

The oil path where the pressure signal switch arranged can also be provided with an endec, so that the pressure signal switch and the endec form another alarm. To decode, the oil path where the pressure signal switch arranged is at first closed, otherwise, the alarm will be triggered. The pressure signal switch functions in warning, rather than controlling the connecting part between the housing and the bolt body.

In the third technical scheme, whenever the endec or the hydraulic converting element is directly or indirectly controls the connecting part between the housing and the bolt body, the endec and the hydraulic converting element are all belongs to the bolt controlling device.

A code control systems comprise the hydraulic converting element and the endec, even the same type of hydraulic elements are employed, the means for decoding are different, because the principles of hydraulic oil paths controlled by the preset oil volume, oil pressure, or flow rate are different from each other. The user outside the locked space must strictly comply with the specific operation steps to unlock the hydraulically-coded lock mechanism. It is difficult to decode only by judging from the appearance, especially when the hydraulically-coded lock mechanism is provided with a plurality of regulating terminals or oil ducts; besides, the decoding process is much more difficult, when the oil path is provided with the pressure signal switch.

Advantages of the invention are summarized hereinbelow: the endec and the hydraulic converting element of the invention employs hydraulic elements of different characteristics to control the connecting part between the housing and the bolt body, so that the invention is advantageous in its multiple control, precision in locating and driving, complicated oil path; furthermore, because the oil in the oil path is mobile, it is very difficult to detect the movement of the oil in the oil path, thereby improving the security of the lock mechanism.

### BRIEF DESCRIPTION OF THE DRAWINGS

The invention is described hereinbelow with reference to the accompanying drawings, in which:

FIG. 1 is a structural diagram of a hydraulically-coded lock mechanism in accordance with Example 1;

FIG. 2 is a schematic diagram of an oil path of a hydraulically-coded lock mechanism in accordance with Example 1;

FIG. 3 is a structural diagram of a hydraulically-coded lock mechanism in accordance with Example 2;

FIG. 4 is a structural diagram of a hydraulically-coded lock mechanism in accordance with Example 3;

FIG. 5 is a schematic diagram of an electric circuit of a hydraulically-coded lock mechanism in accordance with Example 3;

FIG. 6 is a schematic diagram of an oil path of a hydraulically-coded lock mechanism in accordance with Example 3;

FIG. 7 is a schematic diagram of an oil path of a hydraulically-coded lock mechanism in accordance with Example 3;

FIG. 8 is a structural diagram of an display instrument of a hydraulically-coded lock mechanism in accordance with Example 3;

FIG. 9 is a structural diagram of a hydraulically-coded lock mechanism in accordance with Example 4;

FIG. 10 is a structural diagram of a hydraulically-coded lock mechanism in a operated state in accordance with Example 4;

FIG. 11 is a schematic diagram of an oil path of a hydraulically-coded lock mechanism in accordance with Example 4;

FIG. 12 is a structural diagram of a hydraulically-coded lock mechanism in a operated state in accordance with Example 5;

FIG. 13 is a structural diagram of a hydraulically-coded lock mechanism in a operated state in accordance with Example 6;

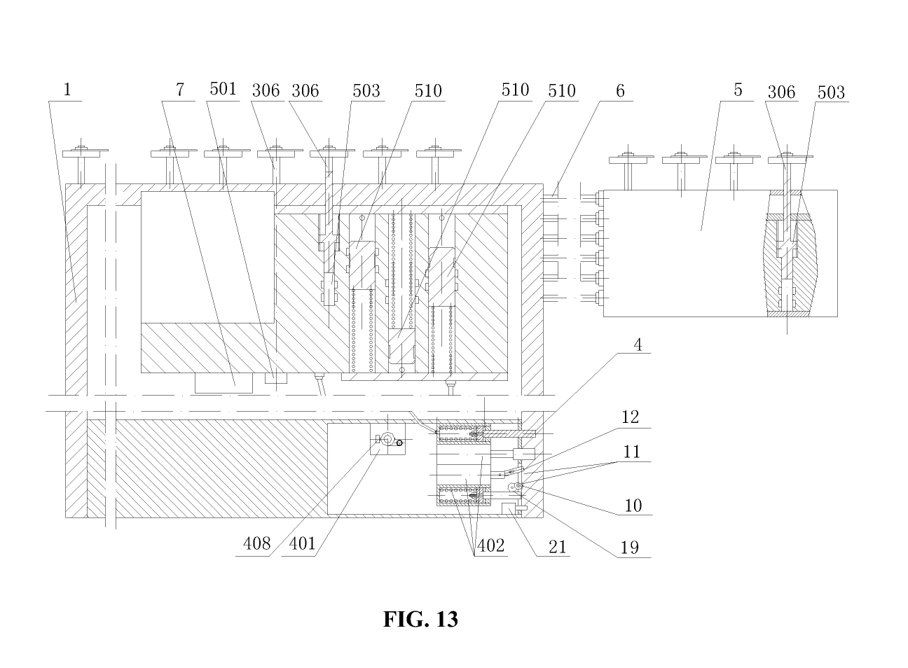

FIG. 14 is a structural diagram of a hydraulically-coded lock mechanism in a operated state in accordance with Example 7;

FIG. 15 is a schematic diagram of an oil path of a hydraulically-coded lock mechanism in accordance with Example 7;

FIG. 16 is a structural diagram of a hydraulically-coded lock mechanism in a operated state in accordance with Example 8;

FIG. 17 is a schematic diagram of an electric circuit of a hydraulically-coded lock mechanism in accordance with Example 8;

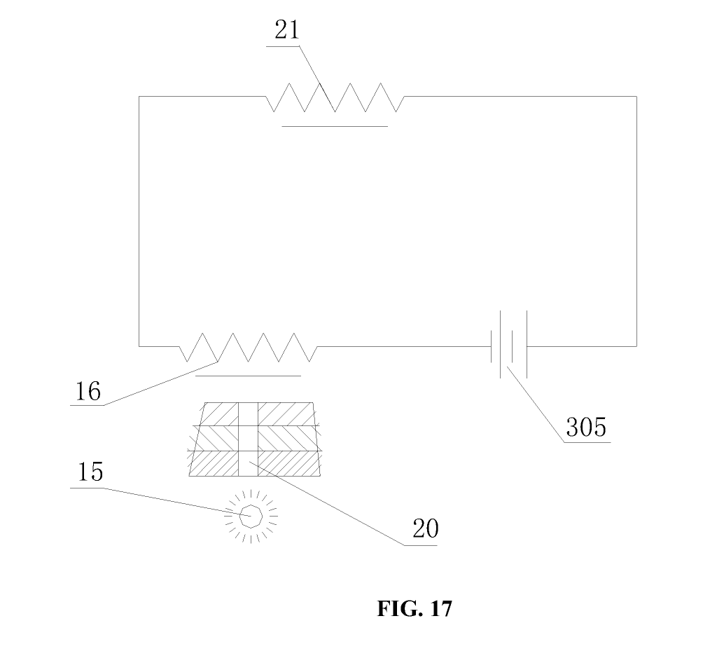

FIG. 18 is a schematic diagram of a speed control valve of a hydraulically-coded lock mechanism in accordance with Example 8;

FIG. 19 is a structural diagram of a hydraulically-coded lock mechanism in a operated state in accordance with Example 9;

FIG. 20 is a schematic diagram of an oil path of a hydraulically-coded lock mechanism in accordance with Example 9; and

FIG. 21 is a schematic diagram of a manual reversal valve of a hydraulically-coded lock mechanism in accordance with Example 9.

### DETAILED DESCRIPTION OF THE EMBODIMENTS

To further illustrate the invention, experiments detailing a hydraulically-coded lock mechanism are described below. It should be noted that the following examples are intended to describe and not to limit the invention.

The term “endec,” as used herein, refers to a device which acts as both an encoder and a decoder.

### Example 1

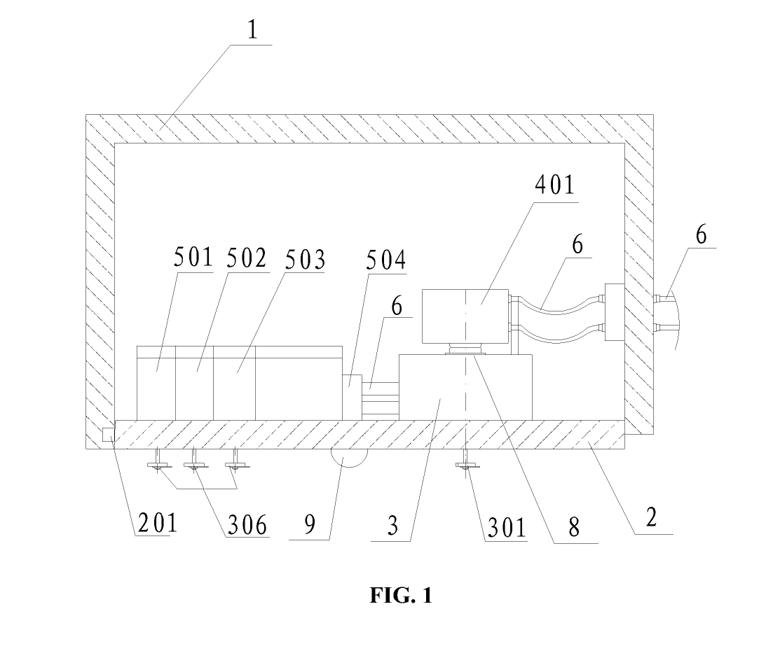

As shown in FIG. 1, a hydraulically-coded lock mechanism is applied in a safe which comprises: a safe body, i.e., a housing 1; and a safe door, i. e., a bolt body 2. An endec 3 is a mechanical endec 1 controlled by a runner. The endec 3 is connected to a switch handle 301 for pulling the bolt body 2 to open the safe door, after unlocking the hydraulically-coded lock mechanism. Except for the switch handle 301, other parts of the endec 3 are arranged inside a locked space. A latching mechanism comprises: a latch 201 disposed on the bolt body, and a slot 101 disposed on the housing 1.

A hydraulic converting element 4 is a hydraulic motor 401 disposed inside the locked space, the hydraulic motor 401 comprises an output shaft. The runner of the endec 3 is disposed on the output shaft of the hydraulic motor 401. The endec 3 is preset with a revolution number and a rotary direction. When the output shaft of the hydraulic motor 401 rotates under the drive of the hydraulic decoding device 5, the latch 201 is unlocked from the slot 101, and the safe door is opened by pulling the switch handle 301.

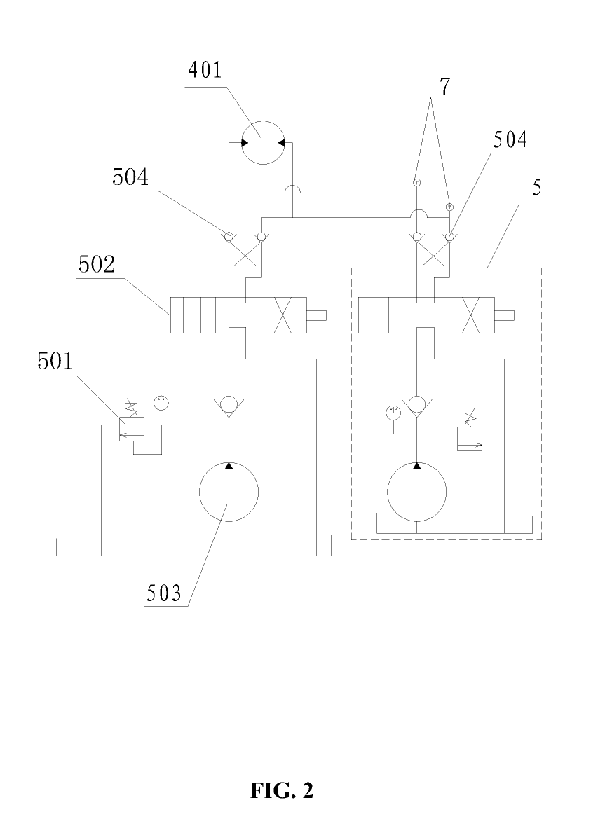

As shown in FIG. 2, the hydraulic decoding device 5 is arranged inside or outside the locked space. The hydraulic decoding device 5 arranged inside the locked space performs a local decoding via a regulating terminal 306; and the hydraulic decoding device 5 arranged outside the locked space performs a remote decoding. In this example, the hydraulic decoding device 5 is disposed inside the locked space, and comprises: a relief valve 501, a reversing valve 502, a hand oil pump 503, a pilot operated check valve 504, and an oil tank. Regulating terminals of the relief valve 501, the reversing valve 502, and the hand oil pump 503 are all disposed outside the locked space. The pilot operated check valve 504 and the reversing valve 502 are directional control valves; the relief valve 501 is a pressure control valve. Another hydraulic decoding device 5 can also be disposed outside the locked space, so that the safe can be unlocked by local decoding or remote decoding. The hydraulic decoding device 5 is connected to the hydraulic converting device 4 via an oil duct 6, and the oil duct 6 is embedded in the wall or under the floor of a building.

To unlock the safe, the hydraulic decoding device 5 drives the output shaft of the hydraulic motor 401 to rotate by supplying oil, and the reversing valve 502 of the hydraulic decoding device 5 changes the rotary direction of the hydraulic motor 401, so that the runner of the endec 3 rotates to decode according to the preset rotary direction and the revolution number.

Furthermore, a pressure signal switch 7 (not shown in FIG.) is arranged on the oil duct 6 of the hydraulic converting element 4 for safety. Any pressure that causes a rotation of the hydraulic converting element 4 will initiate the pressure signal switch 7 to produce a warning signal. A locator 8 is disposed on the output shaft of the hydraulic motor 401, a pilot lamp 9 is disposed on the housing and is in electric connection with the locator 8, so that it is very convenient for a user to know the location and movement of the endec 3.

Main parts of the endec 3 and the hydraulic converting element 4 are all disposed inside the locked space, so that they are not accessible by people outside the locked space, and the safety of the safe is largely improved. Even operating elements of the bolt body 2 are damaged; the safe can be unlocked by connecting oil ducts 6 of other parts to the hydraulic decoding device disposed outside the locked space.

### Example 2

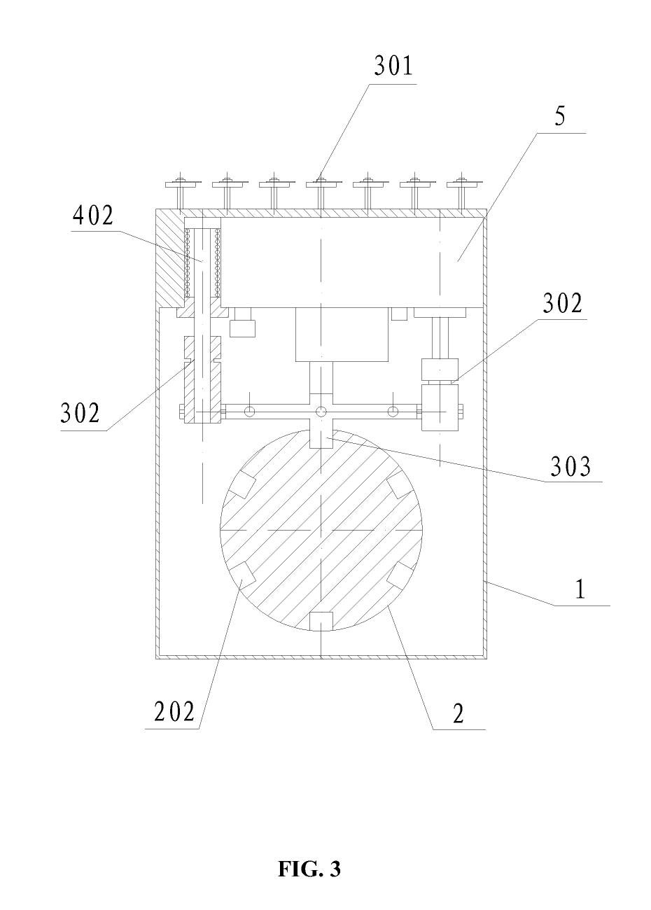

As shown in FIG. 3, a shaft lock mechanism, is a hydraulically-coded lock mechanism controlled by oil supply. In this example, the housing is a shaft sleeve 10, a bolt body 2 is a shaft. An endec 3 is a mechanical endec, and comprises: a switch handle 301, and two positioning slots 302. A latching mechanism comprises: a locking block 303, and a locking slot 202. The locking block 303 is disposed on a connecting bar connected to the two positioning slots 302. The locking slot 202 is disposed on the bolt body 2. Except for the switch handle 301, the positioning slots 302 and the locking block 303 are all disposed inside the locked space. A hydraulic converting element 4 comprises two hydraulic cylinders 402 which are disposed inside the locked space. The two positioning slots 302 are arranged on piston rods of the two hydraulic cylinders 402, respectively. When the positioning slots 302 are extended via the piston rods of the hydraulic cylinders 402, the locking block 303 is correspondingly inserted into the locking slot 202 of the bolt body 2, so that the bolt body 2 is in an irrotational state; and when the positioning slots 302 are retracted via the piston rods of the hydraulic cylinders 402, the blocking block 303 is correspondingly removed from the locking slot 202 of the blot body 2, so that the bolt body is rotatable.

In this example, the mechanical endec is adopted, so that a hydraulic decoding device 5 is needed. The hydraulic decoding device 5 comprises a hand oil pump 503. The hand oil pump controls an input oil volume into an oil path, thereby controlling a moving distance of the hydraulic cylinder 402. Generally, shutoff valves 505 are disposed on an inlet oil path and outlet oil path of the hand oil pump 503, respectively. And a pressure signal switch 7 is arranged on the oil path where the hydraulic converting element 4 is arranged. To decode, the pressure single switch 7 is turned off via the shutoff valve 505 on the inlet oil path of the hand oil pump 503, so that the warning signal is not produced. In general condition when the lock is not used, the pressure signal switch is required to open, and once the pressure of the oil path changes, the warning signal is produced.

The shaft lock mechanism is applied in cars, and is often disposed on a rotary column of a steering wheel, a gearbox shaft, or a motor shaft.

### Example 3

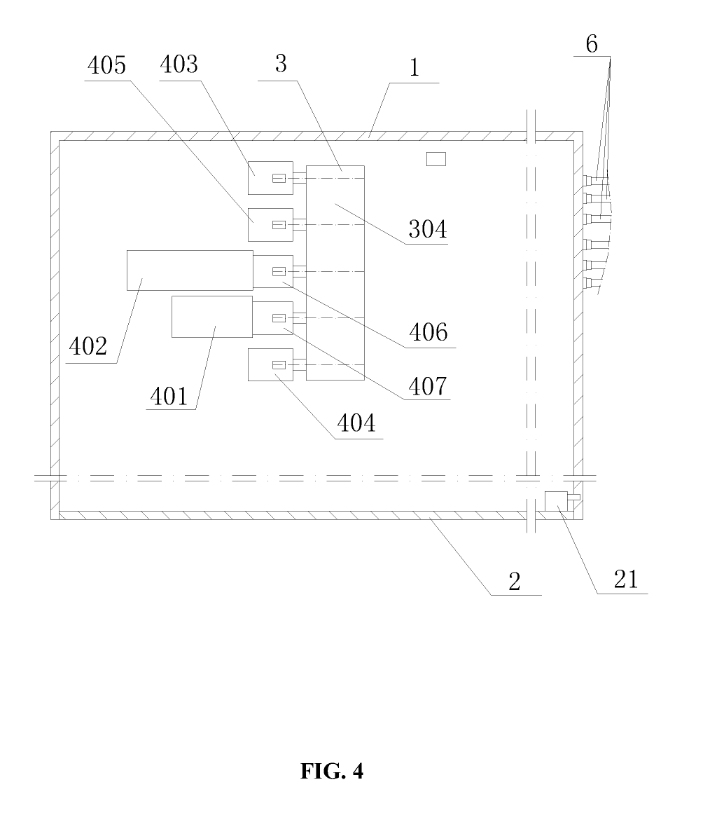

As shown in FIG. 4, a safe controlled by a combination of oil supply, preset pressure, and preset flow volume. The safe comprises: a safe body, i. e., a housing 1; and a safe door, i. e., a bolt body 2. A hydraulic converting element 4 comprises: a hydraulic motor 401; a hydraulic cylinder 402; a pressure relay 403 arranged on an oil duct 6; a flow sensor 404, a pressure sensor 405, a displacement sensor 406 arranged on an oil path of the hydraulic cylinder 402; and a rotational speed sensor 407 arranged on an oil path of the hydraulic motor 401. The endec 3 is an electromechanical endec comprising an electric motor 21 which controls an opening of the bolt body 2; the endec further comprises: a signal detection controller 304, and an electric source 305.

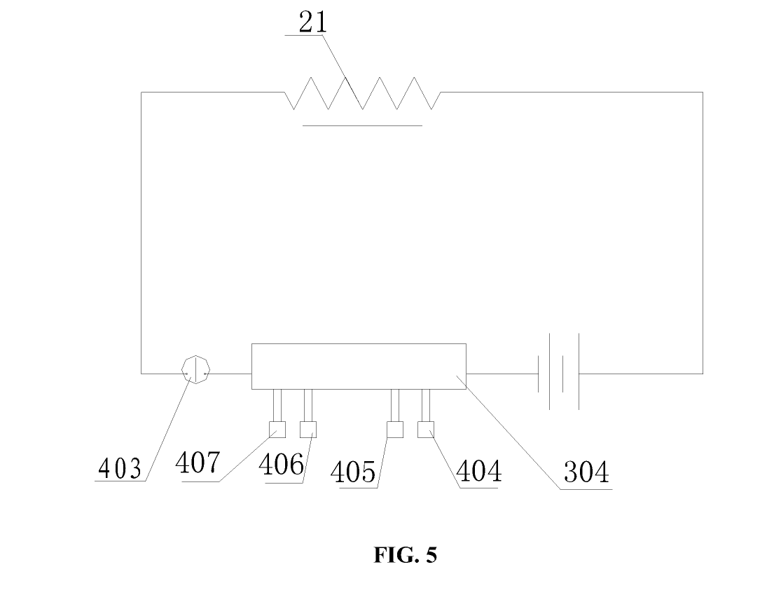

The signal detection controller is correspondingly preset with decoding parameters comprising a decoding pressure range, a decoding flow volume range, a decoding displacement range, and a decoding rotational speed range. As shown in FIG. 5, the signal detection controller 304 is in series connection with the pressure relay which is preset with a decoding pressure range. The flow sensor 404, the pressure sensor 405, a displacement sensor 406, and a rotational speed sensor 407 are connected to the signal detection controller 304. When the pressure value of the oil duct 6 connected to the pressure sensor 405 falls into the decoding pressure range, the displacement value of the displacement sensor 406 falls into the decoding displacement range, the rotational speed value of the rotational speed sensor 407 falls into the decoding rotational speed range, and the flow volume value of the flow sensor 404 falls into the decoding flow volume range; the endec 3 will unlock a connecting part between the housing 1 and the bolt body 2, and the safe door will open.

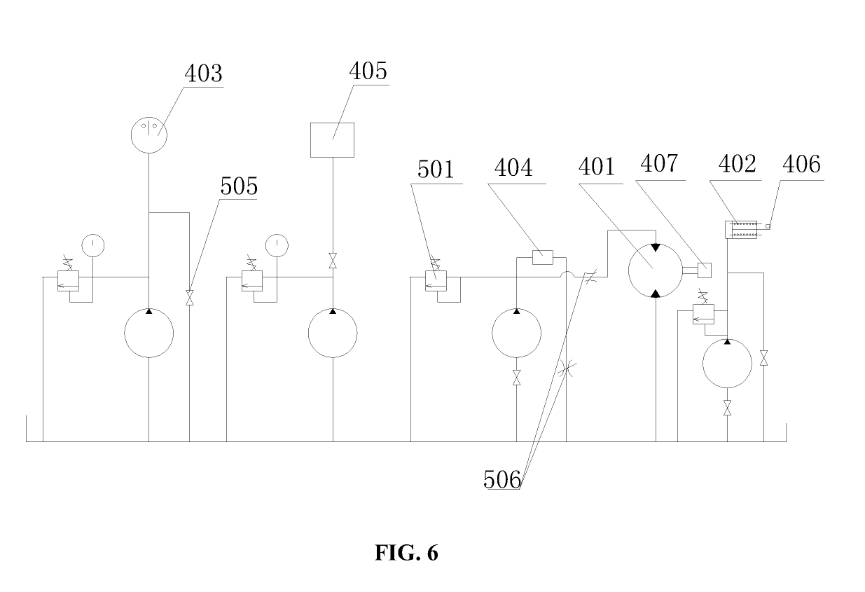

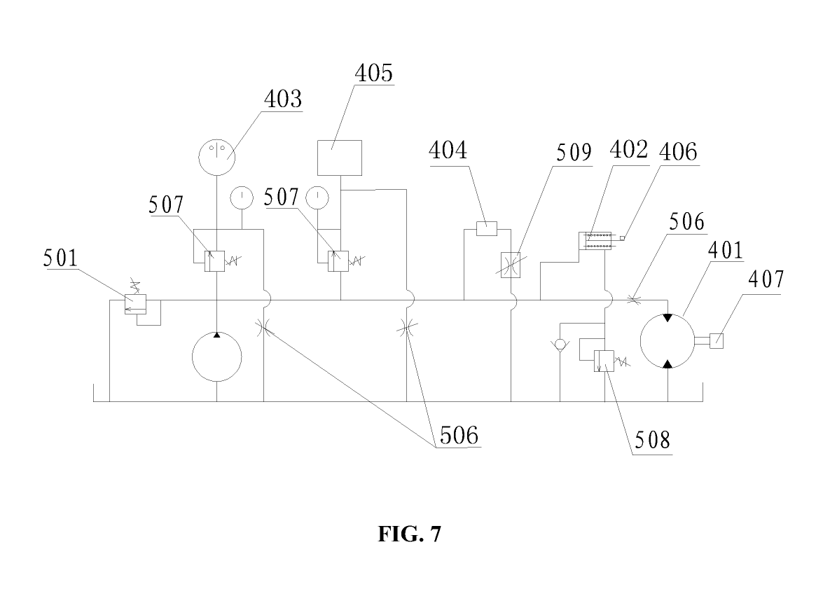

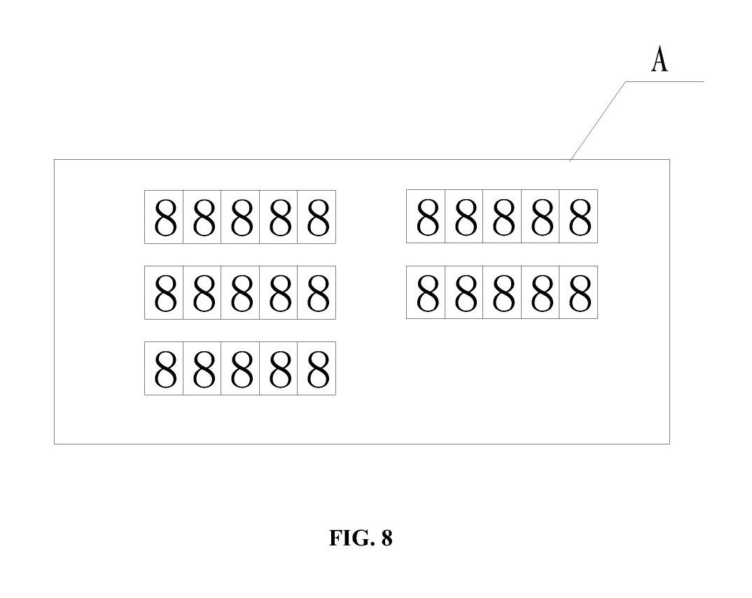

In this example, the endec 3 is the electromechanical endec, so that a hydraulic decoding device 5 is needed. The hydraulic decoding device 5 comprises a relief valve 501, a shutoff valve 505, a throttle valve 506, a pressure reducing valve 507, a back pressure valve 508, and a speed control valve 509. Principles of pressure control and speed control of the hydraulic decoding device 5 are shown in FIGS. 6, and 7, respectively. Furthermore, a display device A, as shown in FIG. 8, is disposed on the safe, so that it is convenient for the user to know the values of different sensors, and unlock the safe according to the values.

### Example 4

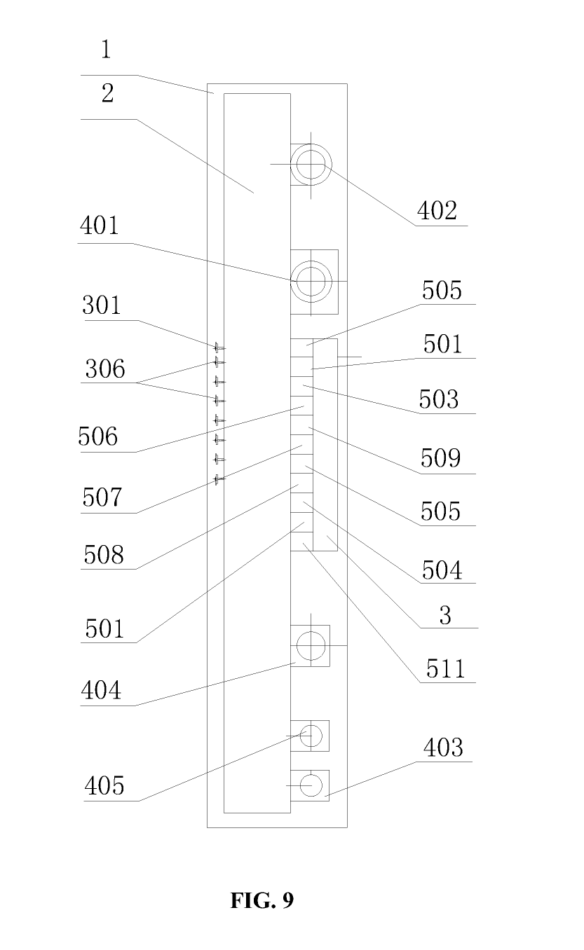

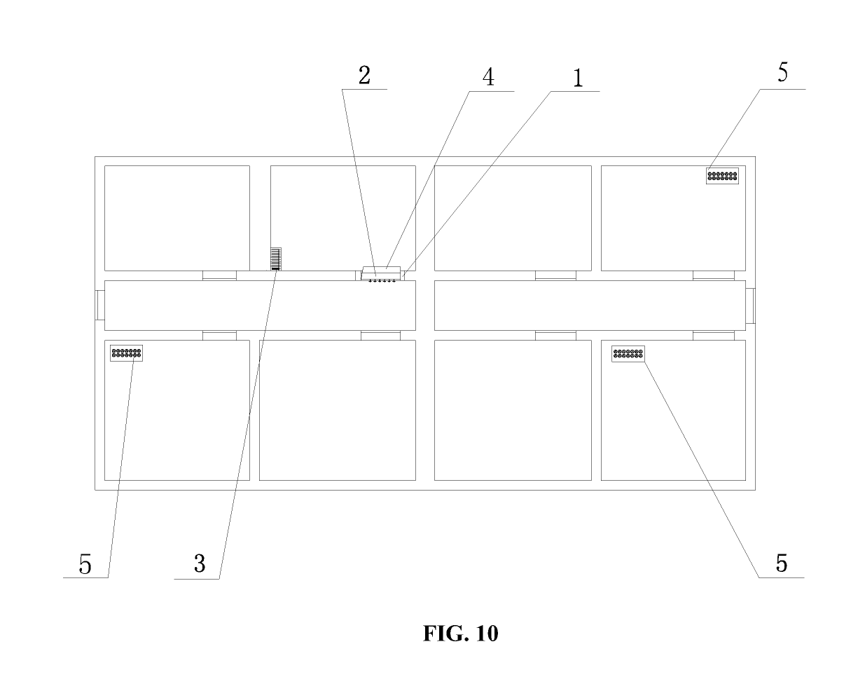

As shown in FIGS. 9, and 10, a burglar-proof door controlled by a combination of oil supply and preset pressure, comprises: a door case, i. e., a housing 1; and a door, i. e., a bolt body 2. A locked space is formed by the housing 1, the bolt body 2, and walls of a building. In this example, the endec 3 comprises: five hydraulic endecs; one electromechanical endec, i. e., an electric motor 21; and a hydraulic converting element 4. The hydraulic endec 3 comprises a plurality of hydraulic regulating elements comprising a regulating terminal 306.

The hydraulic converting element 4 comprises: a hydraulic motor 401 and a connected rotational speed sensor 407; a hydraulic cylinder 402 and a connected displacement sensor 406; a pressure relay 403, a flow sensor 404, and a pressure sensor 405 arranged on an oil duct 6. The above sensors are connected to signal detection controllers 304, respectively, to control the opening of the electric motor 21.

Furthermore, a pressure signal switch 7 is arranged on an oil path of the hydraulic converting element 4. Once a pressure is imposed on the oil path, the pressure signal switch 7 will produce a warning signal. A pilot operated directional control valve 510 is also arranged on the same oil duct on which the pressure signal switch 7 is arranged. In actual operation, the pressure signal switch 7 is turned off by the pilot operated directional control valve 510, so that the warning signal will not be produced.

The hydraulic converting element 4 comprises the following functional units: I. the hydraulic motor 401 and the rotational speed sensor 407 thereof; II. the hydraulic cylinder 402 and the displacement sensor 406 thereof; the pressure relay 403; the flow sensor 404; and the pressure sensor 405. All functional units of the hydraulic converting element 4 are controlled by different hydraulic endecs 3.

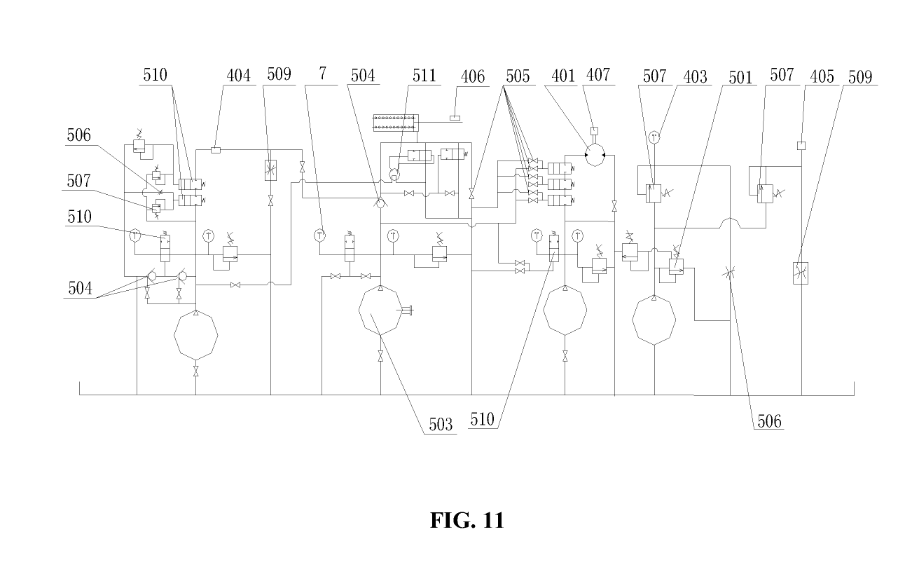

As shown in FIG. 11, a first hydraulic endec 3 is used to control the hydraulic motor 401 and the rotational speed sensor 407 thereof. The first hydraulic endec 3 comprises: there pilot operated directional control valves 510 in series connection; and one relief valve 501. The endec 3 is connected to the hydraulic cylinder 402 via the oil duct 6. The three pilot operated directional control valves 510 are two position two port type, usually in a closed state, and belong to a reversing valve controlled by oil volume. The three pilot operated directional control valves 510 are controlled by another hand oil pump 503 which controls the oil path. Only when the three pilot operated directional control valves 510 are all connected, and the pressure of the relief valve meets the requirement, do the hydraulic motor 401 and the rotational speed sensor 407 start working.

A second hydraulic endec 3 is used to control the hydraulic cylinder 402 and the displacement sensor 406 thereof. The second hydraulic endec 3 comprises: two pilot operated directional control valves 510 in parallel connection; one relief valve 501; one pilot operated check valve 504, and one servo valve 511. The endec 3 is connected to the hydraulic cylinder 402 via an oil duct 6. The pilot operated directional control valves 510 are two position two port type, usually in an open state. The pilot operated check valve 504 is controlled by the flow sensor 404 and the shutoff valve 505. Only when the oil path of the flow sensor 404 is in an operating state and the shutoff valve is open, may the hydraulic cylinder 402 and the displacement sensor 406 start working.

The two pilot operated directional control valves 510 are controlled by oil volume, of which, one is controlled by the hand oil pump 503, and the other is controlled by the servo valve 511. The servo valve 511 is a hydraulic redirector comprising a regulating terminal 306. The movement of a valve core of the pilot operated directional control valves 510 can be controlled by adjusting the regulating terminal 306. Only by correctly operating the two shutoff valves 505 arranged on the oil path of the pilot operated directional control valves 510, the hand oil pump 503, and the servo valve 511, do the two the pilot operated directional control valves 510 close, and may the hydraulic cylinder 402 and the displacement sensor 406 start working.

A third hydraulic endec 3 is used to control the pressure relay 403. The third hydraulic endec 3 comprises: one relief valve 501, one pressure reducing valve 507, and one throttle valve 506. The relief valve 501 is a remote control type, and is controlled by the throttle valve 506 via an oil duct 6. The endec 3 is connected to the pressure relay 403 via an oil duct 6. Pressure in the oil path is controlled by a combination of the relief valve 501, the pressure reducing valve 507, and the throttle valve 506 to fall into the preset pressure range. The electric motor 21 can be initiated by the pressure relay 403 only when the pressure of the oil path reaches the preset pressure. The throttle valve 506 is a variable load.

A fourth hydraulic endec 3 is used to control the flow sensor 404. The fourth hydraulic endec 3 comprises: three pilot operated directional control valves 510 in series connection, two pressure reducing valves 507, one back pressure valve 508, one relief valve 506, and one speed control valve 509. The endec 3 is connected to the flow sensor 404 via an oil duct 6. The three pilot operated directional control valves 510 are two position two port type, and are usually closed. An oil pressure of the pilot operated directional control valves 510 is controlled by the pressure reducing valve 507, the back pressure valve 508, and the relief valve 506; another end of a valve core is controlled by a reset spring. Only when the two pilot operated directional control valves 510 are connected at the same time, does the flow sensor 404 start working; furthermore, the flow volume of the oil path where the flow sensor arranged 404 is controlled by the speed control valve 509.

A fifth hydraulic endec 3 is used to control the pressure sensor 405. The fifth hydraulic endec 3 comprises: one remote control relief valve 501, one relief valve 507, and one speed control valve 509. The endec is connected to the pressure sensor 403 via an oil duct 6, and can be unlocked only by adjusting a combination of the remote control relief valve 501, the relief valve 507, and the speed control valve 509.

In this example, the regulating terminals of the hydraulic endec 3 are disposed outside the locked space, so that the safe can be unlocked locally according to different parameters of the oil path. The endec 3 is functioned in decoding, thus, a hydraulic decoding device 5 is not necessary. A plurality of the hydraulic decoding devices 5 comprising a hand oil pump 503 and a shutoff valve 505 can be arranged in different places, these hydraulic decoding devices 5 are restraint to each other by series connection and/or parallel connection. Only the hydraulic decoding devices in different places are decoded successfully, does the burglar-proof door open.

### Example 5

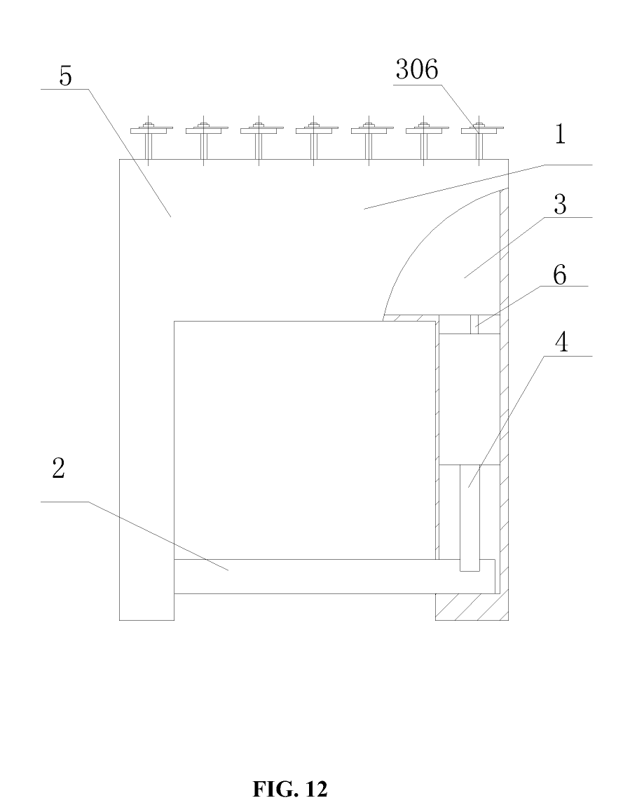

As shown in FIG. 12, a burglar-proof lock mechanism controlled by oil supply, comprises: a lock body, i. e., a housing 1; and a latch, i. e., a bolt body 2. In this example, the hydraulic converting element 4 is a hydraulic cylinder 402. The latch mechanism is connected to a piston rod of the hydraulic cylinder 402. An endec 3 comprises: a hand oil pump 503, and a manual reversal valve 512. Except for regulating terminals 306, other parts of the endec 3 are disposed inside a locked space and connected to the hydraulic converting element 4 via an oil duct 6. The movement of the piston rod of the hydraulic converting element 4 is controlled by different regulating terminals 306. And only operated in compliance with the schematic diagram of the oil path and corresponding data of the endec 3 and the hydraulic converting element 4, is the burglar-proof door unlocked.

### Example 6

As shown in FIF. 13, a safe controlled by a combination of an oil supply and a preset pressure, comprise: a safe body, i. e., a housing 1; and a safe door, i. e., a bolt body 2. A connecting part of the housing 1 and the bolt body 2 is controlled by five hydraulic converting elements 4 comprising four hydraulic cylinders 402 and one hydraulic motor 401. The five hydraulic converting elements 4 are connected to four different latching mechanisms, respectively, for controlling the connecting part of the housing 1 and the bolt body 2. Piston rods of the four hydraulic cylinders 402 are connected to different latching mechanisms, respectively. In this example, the four different latching mechanisms are one rack driving mechanisms 19, one cam mechanism 10, one bolt slot 11, and one connecting bar 12, respectively. The four latching mechanisms are connected together. When the piston rod of the lowest hydraulic cylinder 402 drives the rack driving mechanism 19 to move, the cam mechanism 10, the bolt slot 11, and the connecting bar 12 move driven by one after another. An electric switch 408 is arranged on the hydraulic motor 401. The hydraulic motor 401 controls an electric motor 21. Only when the four hydraulic cylinders 402 drive the different latching mechanisms to move and at the same time the hydraulic motor 401 drives the electric motor 21 to operate, dose the connecting part between the safe body and the safe door open.

In this example, two hydraulic decoding devices are arranged inside and outside the locked space, respectively. The hydraulic decoding device arranged inside the locked space comprises: a pilot operated directional control valve 510, a relief valve 501, and a hand oil pump 503; all parts of the hydraulic decoding device are disposed inside the locked space, except for regulating terminals 306. The hydraulic decoding device 5 arranged outside the locked space comprises a hand oil pump 503 that is a plunger oil pump. The plunger oil pump moves by rotating the regulating terminal 306 via a thread; that is, when the regulating terminal 306 of the hand oil pump 503 rotates for one revolution, the plunger moves down for one crew pitch, so that a certain amount of oil is output. When the plunger moves down to a terminal point, at first a shutoff valve 505 on the outlet oil path of the hand oil pump 503 is turned off, then a shutoff valve 505 on the inlet oil path of the hand oil pump 503 is opened, and finally the regulating terminal 306 of the hand oil pump 503 is rotated, so that the hand oil pump 503 sucks oil from an oil tank. To pump oil, at first the shutoff valve 505 on the inlet oil path of the hand oil pump 503 is turned off, then the shutoff valve 505 on the outlet oil path of the hand oil pump 503 is opened, and finally the regulating terminal 306 of the hand oil pump 503 is rotated.

Provided with the two hydraulic decoding devices 5, the safe can be unlocked by a local decoding and a remote decoding. When one of the two hydraulic decoding devices 5 is malfunctioned, the safe can still be unlocked by another hydraulic decoding device 5.

### Example 7

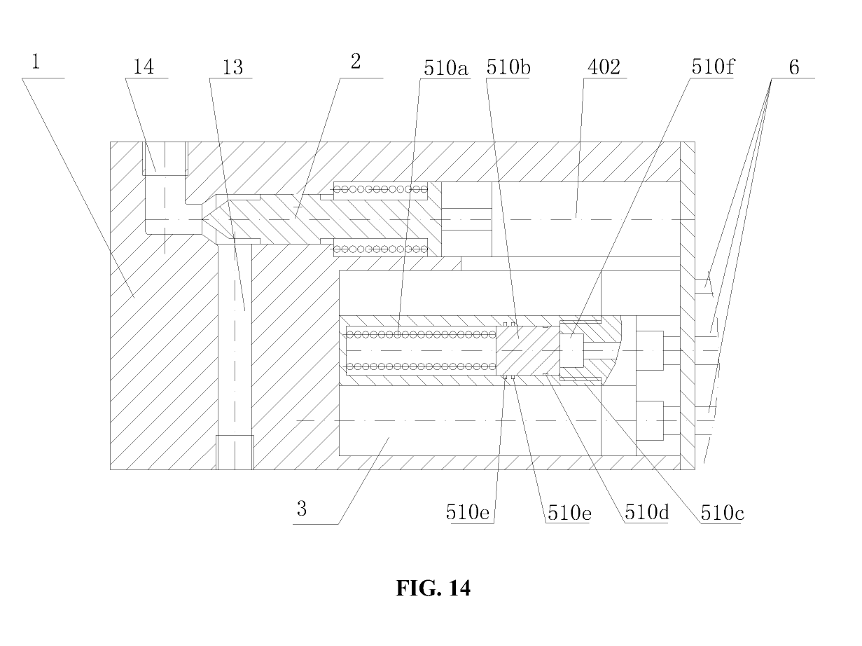

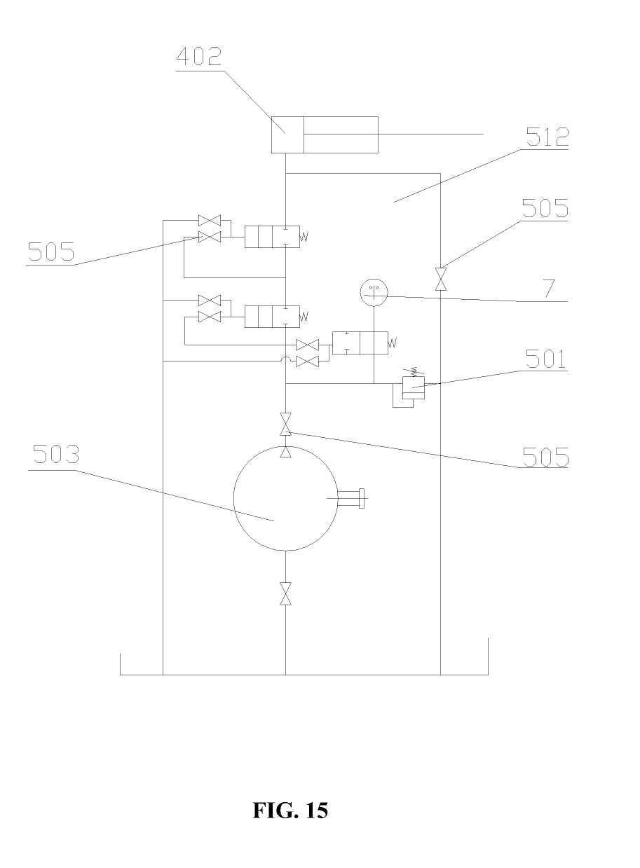

As shown in FIGS. 14, and 15, a burglar-proof valve controlled by oil supply, comprises: a housing 1, and a bolt body 2. A connecting part of the housing 1 and the bolt body 2 comprises two channels 13, 14 of the valve. The channels 13, 14 are controlled by a latching mechanism arranged on an operating terminal of the hydraulic converting element 4. In this example, the hydraulic converting element 4 is a hydraulic cylinder 402; the latching mechanism is a valve core 2. A piston rod of the hydraulic cylinder 402 is connected to one end of the valve core 2 for driving the valve core 2 to move forward and backward. An endec 3 comprises two pilot operated directional control valves 510. A hydraulic decoding device 5 is arranged outside the locked space, and the hydraulic decoding device 5 comprises: a relief valve 501, a hand oil pump 503, a pressure signal switch 7, and a shutoff valve 505.

The pilot operated directional control valves 510 comprises: a spring 510a, a valve core 510b, and a valve body 510c. The valve core 510b is provided with one oil duct 510d. The valve body 510c is provided with three oil ducts, of them, one oil duct is an oil cavity 510f connected to the hydraulic decoding device 5; and the other two oil ducts 510e are arranged on a sliding path of the valve core 510b, and the oil ducts 510e are usually in an open state. The valve core 510b moves driven by a certain oil volume supplied by the hydraulic decoding device 5. Only the valve core 510b moves to a certain position, is the oil duct of the valve core 510b connected to the two oil ducts 510e of the valve body. The hydraulic decoding device 5 then supplies oil to the hydraulic converting element 4 via an oil duct 6, and the latching mechanism in turn decodes driven by the hydraulic converting element 4. Only when the two pilot operated directional control valves 510 are connected at the same time, does the hydraulic decoding device 5 supply oil to the hydraulic converting element 4, thereby opening or closing the channels 13, 14. The schematic diagram of the oil path of the burglar-proof valve is shown in FIG. 15. The burglar-proof valve is applied in fuel tanks of automobiles, motorbikes, or ships, for securing the oil supply of the engine.

### Example 8

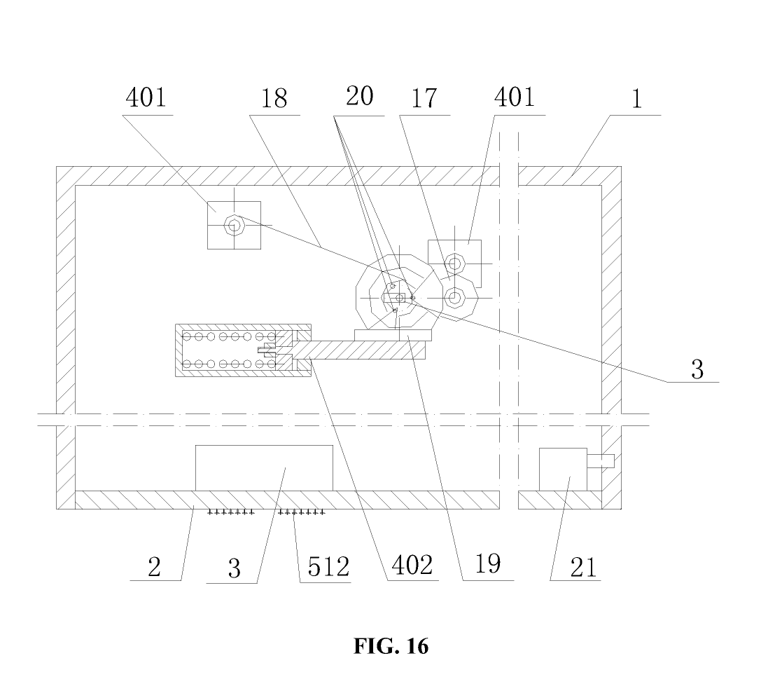

As shown in FIG. 16, a safe controlled by preset oil volume, comprise a safe body, i. e., a housing 1; and a safe door, i. e., a bolt body 2. In this example, the endec 3 comprises an optical-mechanical-electrical endec and a hydraulic endec. The optical-mechanical-electrical endec controls the opening of the bolt body 2 via an electric motor 21. The optical-mechanical-electrical endec comprises: one light source 15, one photoresistor 16, one electric motor 21, one electric source 305, one gear drive mechanism 17, one soft cable and one winch mechanism thereof 18, one rack drive mechanism 19, and three apertures 20. The three apertures 20 are arranged on the gear driven mechanism 17, the soft cable and the winch mechanism thereof 18, and the rack drive mechanism 19, respectively. The hydraulic converting element 4 comprises: two hydraulic motors 401, and one hydraulic cylinder 402. The hydraulic converting device 4 is connected to the endec 3 via an oil duct 6, and supplies oil by adjusting a regulating terminal 306 disposed outside a locked space.

The optical-mechanical-electrical endec is connected to the two hydraulic motors 401 via the gear driven mechanism 17 and the soft cable and the winch mechanism thereof 18, respectively; and connected to the hydraulic cylinder 402 via the rack drive mechanism 19. Once the three apertures 16 are arranged in a line, the photoresistor 16 initiates the electric motor 21 to operate and open a connecting part between the housing 1 and the bolt body 2.

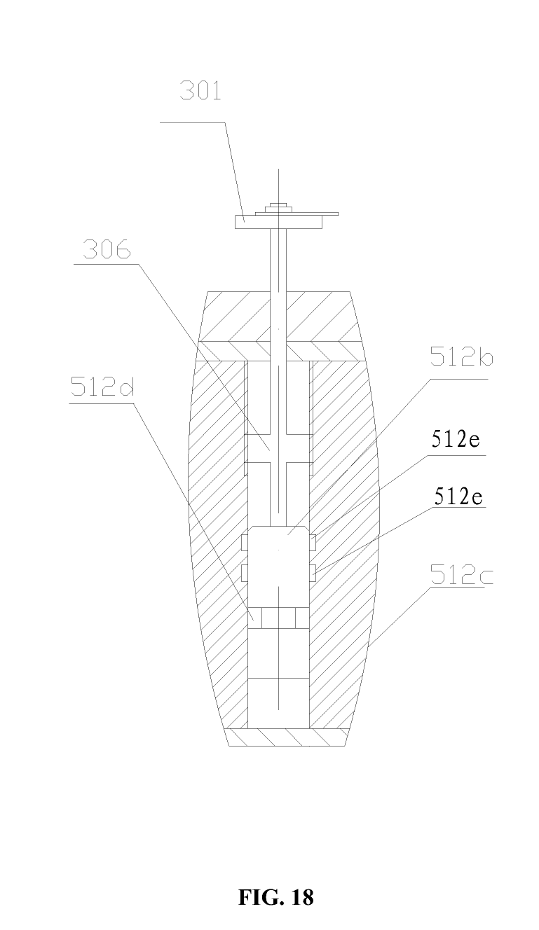

The hydraulic converting device 4 is connected to the hydraulic endec 3 via the oil duct 6, and supplies oil by adjusting the regulating terminal 306 disposed outside the locked space. In this example, the hydraulic endec 3 is a manual reversal valve 512. The manual reversal valve 512 comprises a valve core 512b which is connected to the rack drive mechanism 19 via a screw. As shown in FIG. 18, the manual reversal valve 512 comprises: the valve core 512b, a valve body 512c, and a regulating terminal 306. The valve core 512b is provided with a first oil duct 512d; the valve body 512c is provided with a second oil duct 512e and a third oil duct 512e; and the regulating terminal is the screw. The second oil duct 512e and the third oil duct 512e of the valve body 512c are disposed on a slide of the valve core 512b. The second oil duct 512e and the third oil duct 512e are usually in a disconnected state. When rotating the regulating terminal 306, driven by a combination of the regulating terminal 306 and a thread disposed on the valve body 512c, the valve core 512b moves along an axial direction until the moving distance meet the requirement, then, the first oil duct 512d is connected to the second oil duct 512e and the third oil duct 512e of the valve body 512c at the same time, so that the hydraulic decoding device 5 supplies oil to the hydraulic converting element 4 via the second oil duct 512e and the third oil duct 512e.

The moving distance for connecting the first oil duct 512d to the second oil duct 512e and the third oil duct 512e at the same time is very limited, and is far shorter than the moving distance of the whole valve core 512b. The position of the valve core 512b is determined by the revolution number of the regulating terminal 306, in the meanwhile, the manual reversal valve 512 changes its direction by rotating the regulating terminal 306 for a certain revolutions.

### Example 9

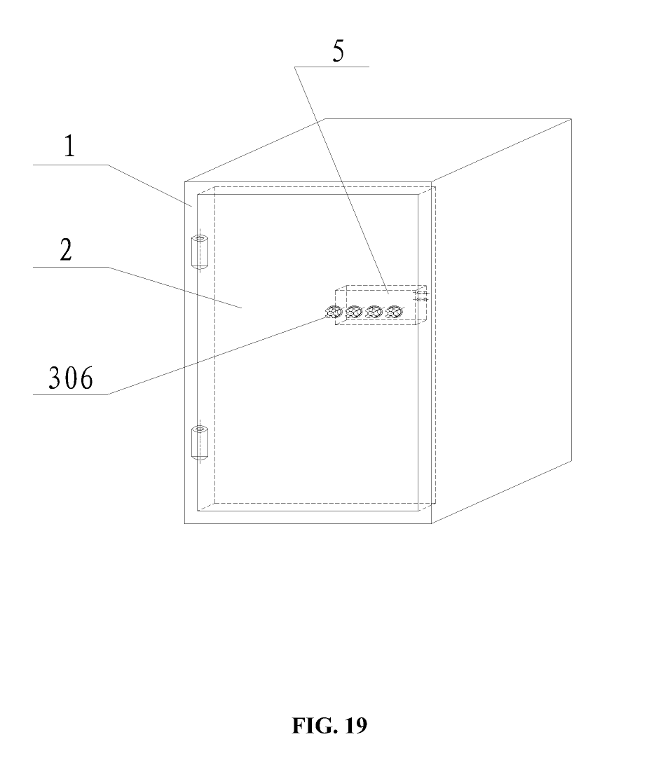

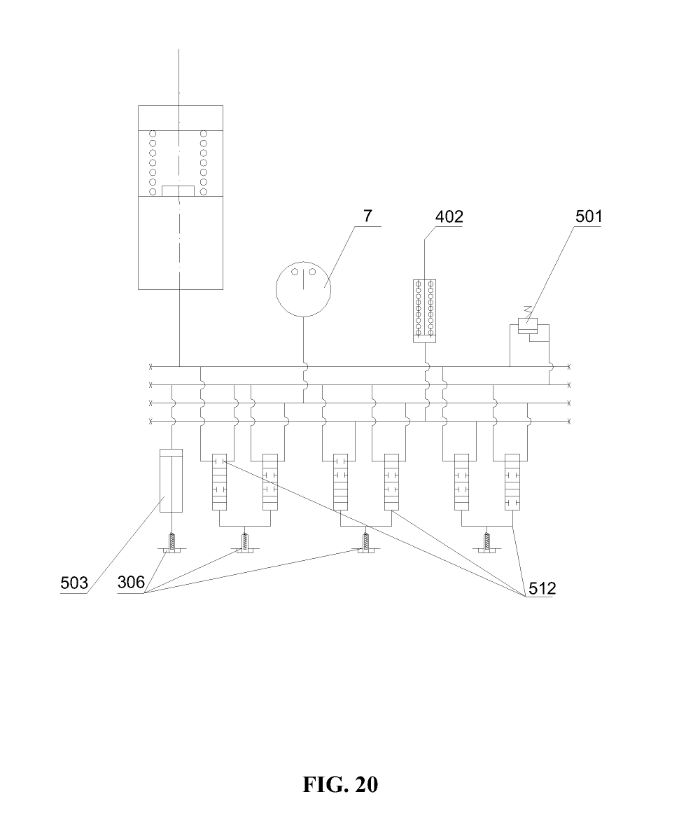

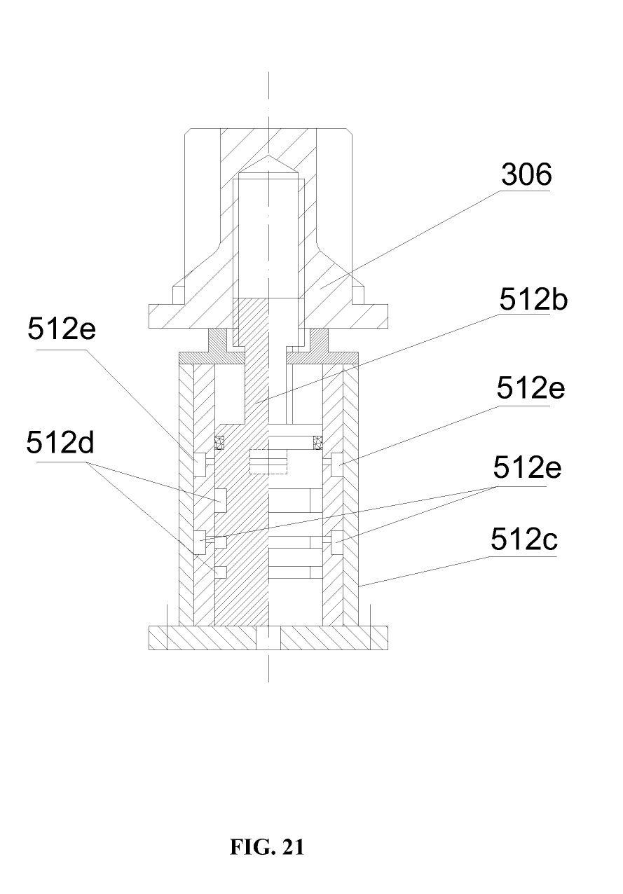

As shown in FIG. 19, a safe controlled by a combination comprising a preset oil supply. A hydraulic converting element 4 is a hydraulic cylinder 402; an endec 3 comprises: a hand oil pump 503, and a manual reversal valve 512. As shown in the schematic diagram of an oil path in FIG. 20, the manual reversal valve 512 employed is a hydraulic control element that is capable to control a plurality of oil paths at the same time, and a structure of the manual reversal valve 512 is the same as that of Example 8. As shown in FIG. 21, the manual reversal valve 512 comprises a plurality of logical control bits; different logical control bits have different functions. By rotating the regulating terminal 306 for certain revolutions, the movement of the valve core 512b is controlled, thereby achieving an opening or closing of different oil paths. Each logical control bit of the manual reversal valve 512 has a certain displacement, only the user who is familiar with these displacements and the revolutions of the regulating terminals 306 can unlock the safe, otherwise, the warning alarm will be triggered. The operating principle of the manual reversal valve 512 has been specifically described in the above text.

The third technical scheme adds a warning alarm, based on the first and the second technical scheme. The alarm is usually a pressure signal switch. The pressure signal switch is arranged on any of the oil ducts that are directly or indirectly connected to the hydraulic converting element. The movement of the hydraulic converting element is pushed by the oil in the oil path. The pressure signal in an oil path between the oil pump and the hydraulic converting element are converted to other signals, such as the electronic signal, by the pressure signal switch, thereby warning that the bolt controlling device is opening. Thus, the pressure signal switch largely improves the security of the lock mechanism.

The oil path where the pressure signal switch arranged can also be provided with an endec, so that the pressure signal switch and the endec form another alarm. To decode, the oil path where the pressure signal switch arranged is at first closed, otherwise, the alarm will be triggered. The pressure signal switch functions in warning, rather than controlling the connecting part between the housing and the bolt body.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A hydraulically-coded lock mechanism for encoding a locked space formed by a housing (1) and a bolt body (2), the hydraulically-coded lock mechanism comprising:
a) a bolt controlling device, the bolt controlling device comprising an endec (3); and
b) a hydraulic converting element (4), said hydraulic converting element (4) being disposed inside the locked space;
wherein
the endec (3) controls a connecting part between the housing (1) and the bolt body (2);
the endec (3) is totally disposed inside the locked space, and connected to the hydraulic converting element (4); and
the hydraulic converting element (4) converts a hydraulic signal into a mechanical movement of the endec (3) or a photoelectric signal to drive the endec (3) to decode.

2. The lock mechanism of claim 1, wherein
the hydraulic converting element (4) comprises: a hydraulic cylinder (402), and/or a hydraulic motor (401);
a piston rod of the hydraulic cylinder (402) and/or an output shaft of the hydraulic motor (401) are/is connected to the endec (3).

3. The lock mechanism of claim 2, wherein the hydraulic converting element (4) further comprises a pressure sensor (405), a flow sensor (404), a rotational speed sensor (407), a displacement sensor (406), a pressure relay (403), or a combination thereof.

4. The lock mechanism of any of claim 1, further comprising a hydraulic decoding device (5) comprising a hydraulic regulating element; wherein
the hydraulic decoding device (5) is connected to the hydraulic converting element (4) via an oil duct (6);
the hydraulic regulating element comprises a manual reversal valve (512), a hand oil pump (503), a pressure control valve, a flow control valve, a directional control valve, or a combination thereof;
at least two hydraulic regulating elements comprise a regulating terminal (306); and
the regulating terminal is disposed outside the locked space.

5. The lock mechanism of any of claim 3, further comprising a hydraulic decoding device (5) comprising a hydraulic regulating element; wherein
the hydraulic decoding device (5) is connected to the hydraulic converting element (4) via an oil duct (6);
the hydraulic regulating element comprises a manual reversal valve (512), a hand oil pump (503), a pressure control valve, a flow control valve, a directional control valve, or a combination thereof;
at least two hydraulic regulating elements comprise a regulating terminal (306); and
the regulating terminal is disposed outside the locked space.

6. The lock mechanism of claim 4, wherein a plurality of hydraulic decoding devices are connected in parallel and/or in series via the oil duct (6).

7. The lock mechanism of claim 5, wherein a plurality of hydraulic decoding devices are connected in parallel and/or in series via the oil duct (6).

8. A hydraulically-coded lock mechanism for encoding a locked space formed by a housing (1) and a bolt body (2), the hydraulically-coded lock mechanism comprising:
a) a bolt controlling device, the bolt controlling device comprising a hydraulic converting element (4); and
b) an endec (3), the endec (3) comprising at least two hydraulic regulating elements comprising a regulating terminal (306);
wherein
the hydraulic converting element (4) is disposed inside the locked space; the endec (3) is partially disposed inside the locked space and connected to the hydraulic converting element (4) via an oil duct; the regulating terminal (306) is disposed outside the locked space; or
the endec (3) further comprises at least two oil duct interfaces disposed outside the locked space for connecting a hydraulic decoding device (5) disposed outside the locked space.

9. The lock mechanism of claim 8, wherein
the hydraulic converting element (4) comprises a hydraulic cylinder (402) and/or a hydraulic motor (401); and
the hydraulic converting element (4) further comprises a pressure sensor (405), a flow sensor (404), a rotational speed sensor (407), a displacement sensor (406), a pressure relay (403) preset with a range of moving distance, or a combination thereof.

10. The lock mechanism of claim 8, wherein
the hydraulic regulating element comprises a hand oil pump (503), a manual reversal valve (512), a pressure control valve, a flow control valve, a pilot operated directional control valve, or a combination thereof; and
the hydraulic regulating element controls parameters of an oil path comprising a pressure, an oil volume, and a flow rate.

11. The lock mechanism of claim 10, wherein
the manual reversal valve (512) comprises: a valve body (512c), a valve core (512b) comprising a thread, and a handle (306);
the valve core (512b) is disposed inside the valve body (512c) and connected to the handle (306); and
a thread is disposed on the handle (306) or the valve body (512c) for controlling a moving distance of the valve core (512b) inside the valve body (512c).

12. A hydraulically-coded lock mechanism for encoding a locked space formed by a housing (1) and a bolt body (2), the hydraulically-coded lock mechanism comprising:
a) a bolt controlling device, the bolt controlling device comprising a hydraulic converting element (4) and an endec (3); and
b) an alarm disposed on an oil path on which the hydraulic converting element (4) arranged;
wherein
the hydraulic converting element (4) is disposed inside the locked space and connected to the endec (3);
the endec (3) is partially or totally disposed inside the locked space; and
the alarm is a pressure signal switch.
